(19) United States
(12) Patent Application Publication
(10) Pub. No.: US 2020/0141220 A1
(43) Pub. Date: May 7, 2020

(54) TRANSPORTABLE DRILLING FLUID PROCESSING SYSTEM

(71) Applicant: Taurus Investment Group Inc., Fort Saskatchewan (CA)

(72) Inventors: Fabien Loranger, Fort Saskatchewan (CA); Timothy MaCartney, Calgary (CA)

(21) Appl. No.: 16/179,900

(22) Filed: Nov. 3, 2018

(51) Int. Cl. E21B 43/34; B01D 21/26

(52) U.S. Cl. CPC E21B 43/34; B01D 2257/702; B01D 2221/04; B01D 21/262

(57) ABSTRACT

A drilling fluid processing system for processing drilling fluid to remove solids and hydrocarbons from the drilling fluid at a drill site includes a transportable skid upon which equipment of the system is mounted and is transportable together as a unit. Equipment mounted to the skid include separator tanks, settling tanks, pumps, heating system, polymer injection system, vacuum system, and centrifugal separators. The system further includes a centrifugal separator support platform that is movable between a raised, operation position and a lowered, transport position. Additionally, the system is easily configured to operating in several different process operation modes according to a desired drilling fluid treatment.

### FIELD OF THE INVENTION

The invention relates to systems for separating solids and fluids from drilling fluid. More particularly, the invention relates to a drilling fluid separator system supported by a single transportable skid and that is configurable for operating in several different separating operations.

### BACKGROUND OF THE INVENTION

Wells for recovering hydrocarbons are created by drilling a borehole into an underground formation using a drill mounted to the end of a drill string. Drilling fluids are used when drilling the borehole to lubricate and cool the drill bit and to flush solids from the borehole to the surface. Drilling fluids are a mixture of various chemicals in a water or oil-based solution and can be very expensive to manufacture. Accordingly, it is desirable to recycle as much drilling fluid as possible. The drilling fluid is recycled through one or more processes that strip the solids from the fluid before the solids are disposed of

Often the stripping processes begins with shale shakers where the drilling fluid flows after returning to the surface. Shale shakers remove large solids from the drilling fluid and form a slurry comprising drilling fluid, finer solids, and often liquid hydrocarbons that are admixed with the drilling fluid and coat the solids.

Additional processing of this slurry is required before disposal to further strip the solids and separate the hydrocarbons from the drilling fluid. Specialized equipment are transported to the wellsite and assembled to form a process flow through which the slurry is circulated through the equipment to remove and separate solids and hydrocarbons from the slurry. Often, the equipment is transported to the wellsite using several skids carrying the equipment. And, once at the wellsite, the skids are carefully arranged so that the equipment can be connected to form a desired process flow.

While the systems heretofore work, there are drawbacks. Particularly, it can be expensive to transport several skids to the wellsite and then once at the wellsite carefully placing the skids so that the equipment on one skid can be connected to the equipment on another skid. Additionally, connecting equipment between the skids is time consuming, which also increases setup and operational costs. According, there remains a need and desire in the art for a system that overcomes these and other drawbacks to existing systems.

### SUMMARY OF THE INVENTION

Embodiments of the present invention provide a drilling fluids processing system that overcomes disadvantaged and drawback to existing drilling fluid processing systems. And in doing so provided a system that is more cost efficient and economical to operate.

Embodiments of the invention provide a transportable drilling fluid processing system for separating components of drilling fluid using one or more process operations in a single transportable system.

In general, in one aspect, a drilling fluid processing system has a transportable skid, first and second separator tanks mounted to the transportable skid, and a plurality of settling tanks mounted to the transportable skid. The plurality of settling tanks and the first and second separator tanks are fluidically connected for selective flow therebetween. A centrifuge supporting platform is mounted to the skid and is movable between a stored position during transport of the skid and an operating position. First and second centrifugal separators are mounted to centrifuge supporting platform. First and second pumps are mounted to the transportable skid. Each of the first and second pumps have an inlet and an outlet, wherein the outlet of the first pump is connected to an inlet of the first centrifugal separator and the outlet of the second pump is connected to an inlet of the second centrifugal separator. A suction line has multiple valves and connect the inlets of first and second pumps to the first and second separator tanks and to each of the plurality of settling tanks, such that the first and second pumps may draw from one or more selected tanks. One or more chemical tanks are mounted to the transportable skid and are fluidically connected to at least one of the first and second separator tanks and the plurality of settling tanks. A fluid heater is mounted to the transportable skid and is fluidically connected to at least one of the first and second separator tanks and the plurality of settling tanks. One or more agitators have an outlet into one or more of the first and second separator tanks and a circulation pump is connected to the suction line and to the one or more agitators such the circulation pump draws from one or more settling tanks and discharges to the one or more agitators. And a vacuum surface skimmer is mounted to the skid and operably connected to one or more of the plurality of settling tanks.

There has thus been outlined, rather broadly, some features of the invention in order that the detailed description thereof that follows may be better understood and in order that the present contribution to the art may be better appreciated.

Numerous objects, features, and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in several ways. Also, it is to be understood that the phraseology and terminology employed herein are for descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is diagrammatic perspective view of a drilling fluids processing system constructed in accordance with an embodiment of the invention, shown with centrifugal separators removed for clarity;

FIG. 2 is a diagrammatic top view of a drilling fluids processing system constructed in accordance with an embodiment of the invention, shown with centrifugal separators removed for clarity;

FIG. 3 is a diagrammatic side view of a drilling fluids processing system constructed in accordance with an embodiment of the invention, shown with a movable centrifugal separator support platform in a raised, operation position;

FIG. 4 is a diagrammatic side view of a drilling fluids processing system constructed in accordance with an embodiment of the invention, shown with a movable centrifugal separator support platform in a lowered, transport position;

FIG. 5 is a diagrammatic end view of a drilling fluids processing system constructed in accordance with an embodiment of the invention, shown with a movable centrifugal separator support platform in a raised, operation position;

FIG. 6 is a first schematic view showing fluidical connection among various components of a drilling fluids processing system constructed in accordance with an embodiment of the invention;

FIG. 7 is a second schematic view showing fluidical connection among various components of a drilling fluids processing system constructed in accordance with an embodiment of the invention; and

FIG. 8 is a diagrammatic side view of a settling tank of a drilling fluids processing system constructed in accordance with an embodiment of the invention, showing an internal baffle and a surface skimmer.

### DETAILED DESCRIPTION OF THE INVENTION

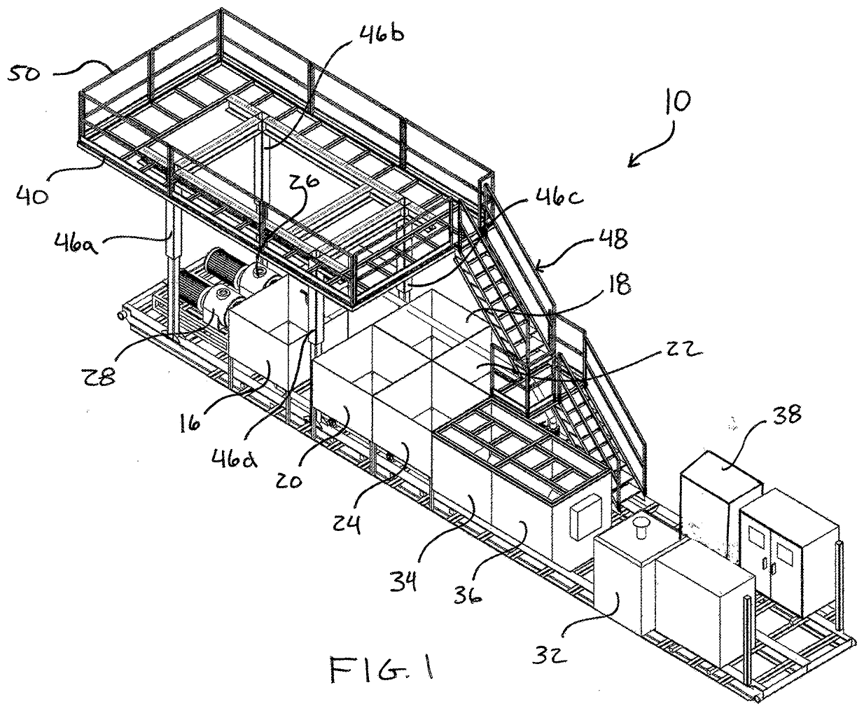

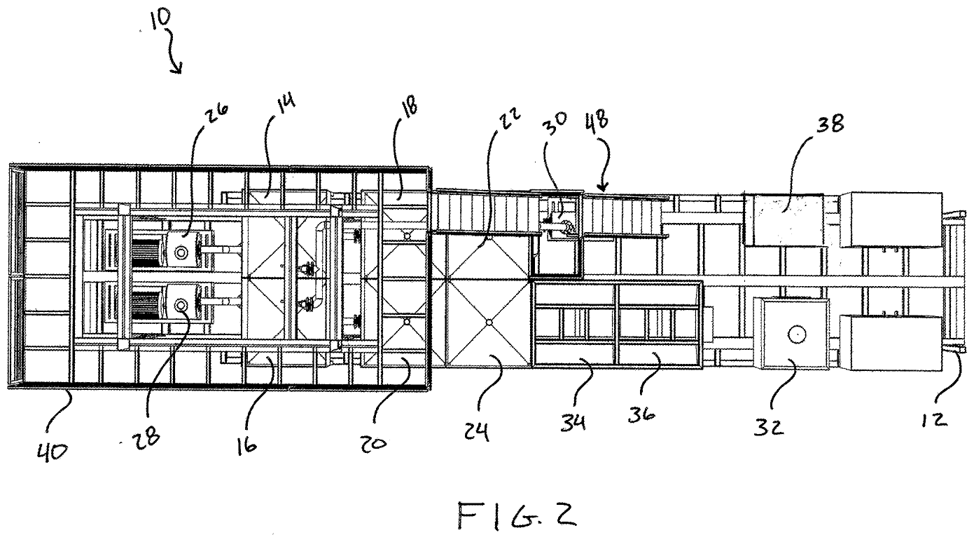

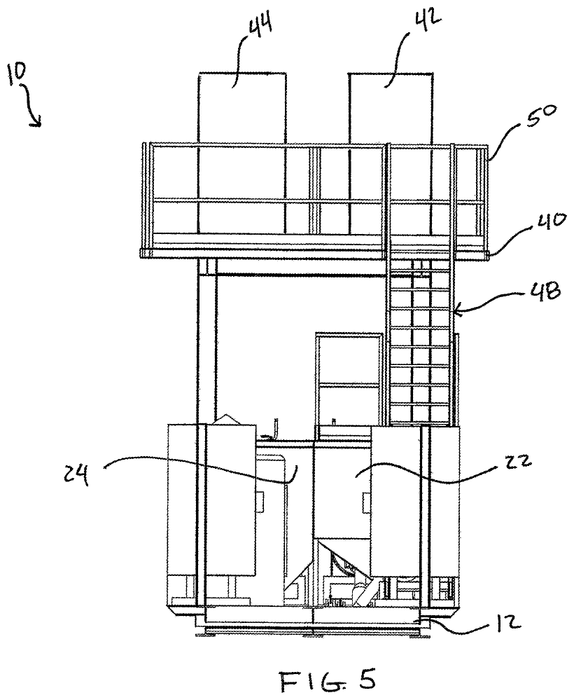

Referring initially to FIGS. 1 through 5, there is shown an embodiment of a drilling fluid processing system 10 in accordance with an embodiment of the invention. System 10 can be used in separating different components in a slurry that contains liquid hydrocarbons, solids, and fluid. For example, system 10 is useful in separating components drilling fluid used in a drilling operation. In certain applications, system 10 can be used after a rig or shale shaker to receive a slurry therefrom after larger cuttings are removed from the drilling fluid by the shaker.

The system 10 includes a skid 12 having attached or otherwise mounted thereto various equipment of the system to allow loading of the system onto a trailer towable by a truck for transport of all the equipment as a unit in a single trip. In the depicted embodiment, the system 10 includes first and second separator tanks 14 and 16, and a plurality of settling tanks, representatively, tanks 18-24. Tanks 18-24 are mounted to the skid 12 and generally arranged in a 2-by-3 tank bank. Each tank 14-24 has a hopper-shaped or cone-shaped bottom for collecting solids that settle from fluid in the tanks. As described herein, tanks 14-24 are fluidically connected by valves that are configurable to change the direction of fluid flow through the tanks according to a desired process.

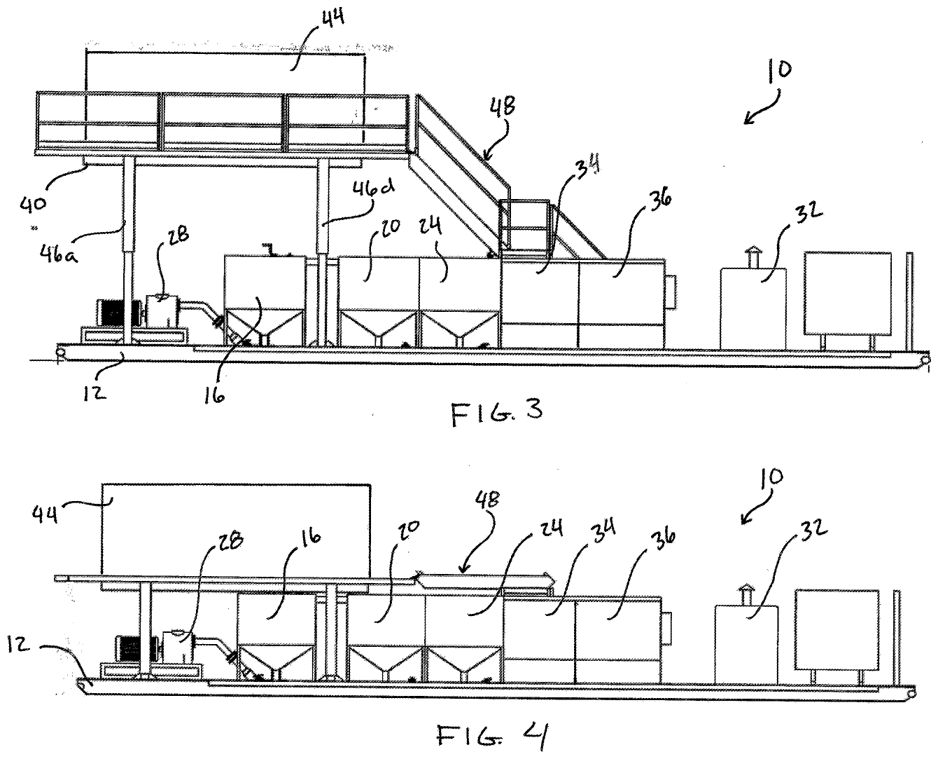

The system 10 further includes pumps 26, 28, and 30, a heating system 32, one or more chemical tanks 34 and 36, and a vacuum system 38 that are mounted to the skid 12. System 10 also includes a centrifuge supporting platform 40 that is attached to the skid 12 and that is configured to support a pair of centrifugal separators 42 and 44. The platform 40 is movable between a stored position for transport (FIG. 4) and a raised, operating position (FIG. 3). As shown, the platform 40 is mounted to a plurality of extensible posts 46a-46d that are extended and retracted to move the platform between the two positions. Posts 46a-46d may be hydraulically operated. The platform 40 includes an articulating stairway 48 that folds when the platform is moved. Additionally, the platform and stairway can include railings 50.

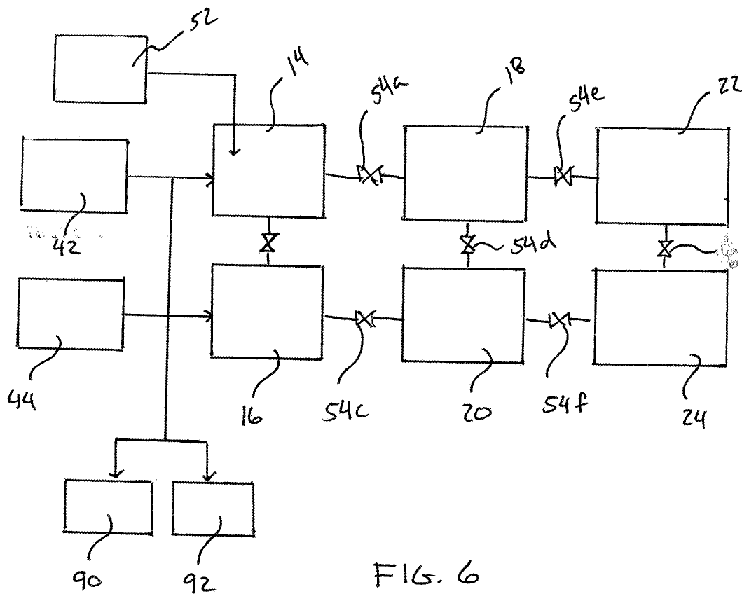

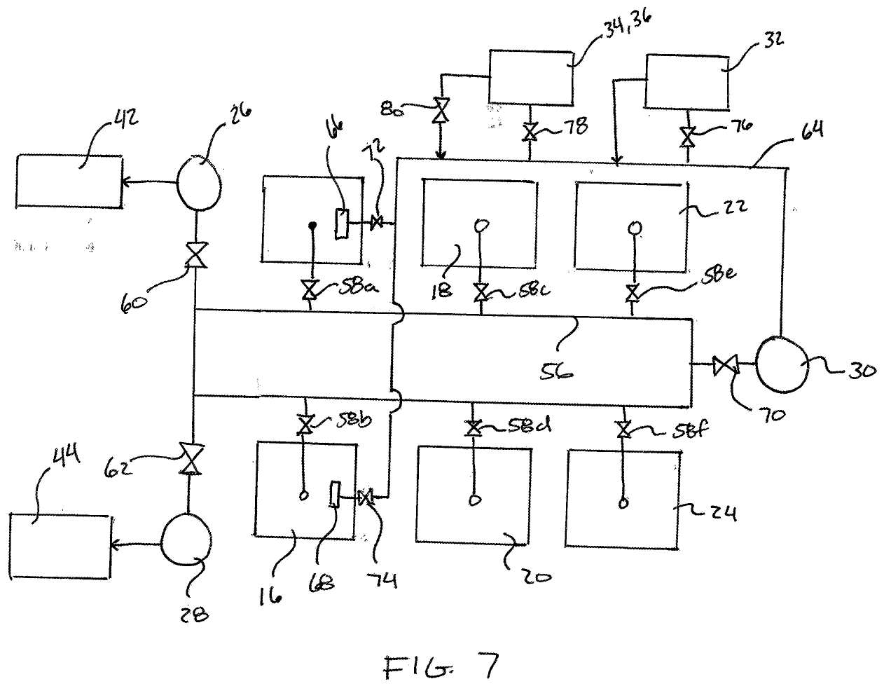

In FIG. 6 there is shown a schematic that illustrates a fluidic connection between tanks 14-24, centrifugal separators 42 and 44, and a shale shaker 52. In the depicted embodiment, tank 14 is connected to shale shaker 52 to receive a slurry therefrom for processing by the system 10. Tanks 14 and 16 are connected to centrifugal separators 42 and 44 to selectively receive the liquid or solids discharge of the separators by either, or both tanks. The centrifugal separators 42 and 44 are also selectively connected to a shale bin 90 to receive the solids discharge from either or both separators. The centrifugal separators 42 and 44 are also selectively connected to a drill rig 92 to receive the liquid discharge of the either or both separators.

Additionally, as shown, each tank 14-24 is connected to more than one other tank to allow for multiple flow configurations between the tanks. Specifically, tank 14 is connected to tank 16 and tank 18 by valves 54a and 54b, respectively. Tank 16 is further connected to tank 20 by valve 54c. In turn tanks 18 and 20 are connected by valve 54d. And tank 18 is connected to tank 22 by valve 54e, tank 20 is connected to tank 24 by valve 54f, and tanks 22 and 24 are connected by valve 54g. To this end, valves 54a-54g can be configured to control how fluid flows through the series of tanks.

For example, valves 54a-54g can be set in a configuration that allows fluid to flow in series from tank 14 to tank 18 to tank 22, and simultaneously flow in series from tank 16 to tank 20 to tank 24. In another example, valves 54a-54g can be set in a configuration that allows fluid to flow in series from tank 14, to tank 16, to tank 20, to tank 18, to tank 22, and then to tank 24. These are only two examples, and the valves 54a-54g may be set in other configurations to control the fluid flow path through the tanks 54a-54g as needed to achieve a desired flow path.

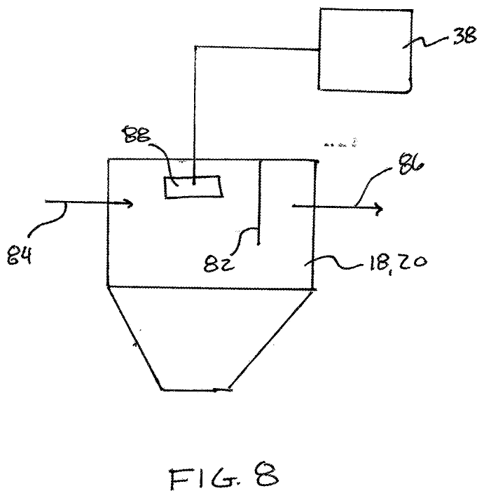

In FIG. 7 there is shown a schematic that illustrates a fluidic connection between tanks 14-24, pumps 26, 28, and 30, heater 32, chemical tanks 34 and 36, and centrifugal separators 42 and 44. As shown, each tank 14-24 is connected at an outlet through its bottom to a suction line 56 by valves 58a-58f. The inlet of pump 26 is connected to suction line 56 via valve 60 and the outlet or discharge of pump 26 is connected to the inlet of centrifugal separator 42. Similarly, the inlet of pump 28 is connected to suction line 56 via valve 62 and the outlet or discharge of pump 28 is connected to the inlet of centrifugal separator 44. To this end, valves 58a-58f, 60, and 62 can be configured to control how fluid is drawn from the bottom of the tanks 14-24 by pumps 26 and 28 via suction line 56 and then into the inlets of the centrifugal separators 42 and 44.

As further shown, the inlet of pump 30 may be connected to suction line 56 via valve 70 and its outlet or discharge connected to a jet line 64 which feeds one or more agitators 66 and 68 disposed in tanks 14 and 16. Valves 72 and 74 are operable to select operation of agitators 66 and 68, respectively. Agitators operate to stir the slurry in tanks 14 and 16 under a pressurized jetting. Alternatively, the inlet of pump 30 could be connected to tanks 22 and/or 24 at a position toward the top of the tanks (i.e., through the sidewall of the tank at a position toward the top).

Additionally, the heater system 32 may be fluidically connected to the jet line 64 to heat fluid in the system, similarly chemical tanks 34, 36 may be fluidically connected to the jet line for injecting chemical into the process flow, such as for example a flocculant. Valves 76, 78 and 80 may be operated to control the fluid connection between the jet line 64, the heater system 32, and chemical tanks 34, 36. Ideally, the heater system is capable of heating 30 cubic meters of fluid to 65 degrees Celsius within a few hours and maintain that temperature in minus 50 degrees Celsius ambient temperature.

In FIG. 8 there is a diagrammatic side view of tanks 18, 20 illustrating the tanks with an internally disposed baffle 82. The baffle 82 extends downwardly into the tank volume from the top and between the sidewalls to divide the top portion of the tank. The baffle 82 extends into the tank below fluid inlet 84 and fluid outlet 86. The purpose of baffle 82 is to prevent liquid hydrocarbons from passing through outlet 86 and allows them to be skimmed from the top of each tank by the surface skimmer 88 that is connected to the vacuum system 32.

As discussed above, an important aspect of system 10 is that it can be configured to run in several different process operations. In an example, system 10 can be configured to run in a floc operation. In a floc operation, drilling fluid is introduced into the system into tank 14. The valves 54a-54g are set so that fluid flows in series from tank 14 to tank 16, from tank 16 to tank 20, from tank 20 to tank 18, from tank 18 to tank 22, and then from tank 22 to tank 24. Polymers are introduced into the 64 from the chemical tanks 34, 36 and then into tank 14. The polymers bind to the solids in the drilling fluid, causing the solids to settle to the bottom of the tanks. Valves 58a-58f, 60, and 62 are set so that pumps 26 and 28 draw the solids from the bottom of the tanks through suction line 56 and fed to centrifugal separators 42 and 44. The fluid discharge from the separators 42 and 44 is sent back to the drilling rig and the solids from the separators are discharged into a shale bin.

In another example, system 10 can be configured to run in a drilling fluid (mud) stripping operation. In this operation, drilling fluid is introduced into the system into tank 14. The valves 54a-54g are set so that fluid flows in series from tank 14 to tank 16, from tank 16 to tank 20, from tank 20 to tank 18, from tank 18 to tank 22, and then from tank 22 to tank 24. Polymers are introduced into the 64 from the chemical tanks 34, 36 and then into tank 14. The polymers bind to the solids in the drilling fluid, causing the solids to settle to the bottom of the tanks. Valves 58a-58f, 60, and 62 are set so that pumps 26 and 28 draw the solids from the bottom of the tanks through suction line 56 and fed to centrifugal separators 42 and 44. The fluid discharge from the separators 42 and 44 is sent back to tank 14 and the solids from the separators are discharged into a shale bin.

In another example, system 10 can be configured to run in a double wash operation. In this operation, valves 54a-54g are set so that fluid flows in two parallel paths through the tanks 14-24. The first path including a flow in series from tank 14 to tank 18, and from tank 18 to tank 22 in a first wash cycle. The second path including flow in series from tank 16 to tank 20 and from tank 20 to tank 24 in a second wash cycle. Valves 58a-58f, 60, and 62 are set so that pump 26 draws from the bottom of tanks 14, 18, and 22 and feds centrifugal separator 42, and so that pump 28 draws from the bottom of tanks 16, 20, and 24 and feds centrifugal separator 44. The system 10 is further configured so that the solids discharged from separator 42 are fed to tank 16 and the fluid discharged from separator 42 to fed back to tank 14. The system 10 is further configured so that the clean solids discharged from separator 44 are fed to a shale bin and the fluid discharged from separator 44 are fed back to tank 16.

In operation, drill cuttings or solids are introduced into tank 14 where they are agitated by agitator 66 with heated water by a flow through the gun line 64 by pump 30 to separate hydrocarbons from the solids. As the fluid flows from tank 14 to tank 18 and then to tank 22, the solids settle to the bottom of the tanks, where they are drawn by pump 26 and fed to separator 42. The baffle in tank 18 captures hydrocarbons in tank 18, which are then vacuumed from surface of the fluid in tank 18 by the vacuum system 38 via surface skimmer 88. The fluid that flows to tank 22 is drawn by pump 30 and pumped back to tank 14. The fluid discharged from separator 42 is fed back to tank 14 and the solids discharged from separator 42 are fed to tank 16.

In tank 16, the solids are agitated by agitator 68 with heated water by a flow through the gun line 64 by pump 30 to separate hydrocarbons from the solids. As the fluid flows from tank 16 to tank 20 and then to tank 24, the solids settle to the bottom of the tanks, where they are drawn by pump 28 and fed to separator 44. The baffle in tank 20 captures hydrocarbons in tank 20, which are then vacuumed from surface of the fluid in tank 18 by the vacuum system 38 via surface skimmer 88. The fluid that flows to tank 24 is drawn by pump 30 and pumped back to tank 16. The fluid discharged from separator 44 is fed back to tank 16 and the clean solids discharged from separator 44 are fed to a shale bin for disposal.

While embodiments of the invention have been described in a well drilling environment, it is contemplated that the system can be used in any situation where there is a requirement for high volume removal of solids from a slurry, such as, for example in treating a tailings pond.

Several embodiments of the invention have been described. Nevertheless, it will be understood that various modifications may be made without departing from the spirit and scope of the invention. Accordingly, other embodiments are within the scope of the following claims.

What is claimed is:

1. A drilling fluid processing system comprising:
a transportable skid;
first and second separator tanks mounted to said transportable skid;
a plurality of settling tanks mounted to said transportable skid;
said plurality of settling tanks and said first and second separator tanks fluidically connected for selective flow therebetween;
a centrifuge supporting platform mounted to said skid and being movable between a stored position during transport of said skid and an operating position;
first and second centrifugal separators mounted to centrifuge supporting platform;
first and second pumps mounted to said transportable skid, each of said first and second pumps having an inlet and an outlet, wherein said outlet of said first pump is connected to an inlet of said first centrifugal separator and said outlet of said second pump is connected to an inlet of said second centrifugal separator;
a suction line having multiple valves and connecting said inlets of first and second pumps to said first and second separator tanks and to each of said plurality of settling tanks, such that said first and second pumps may draw from one or more selected tanks;
one or more chemical holding tanks mounted to said transportable skid and fluidically connected to at least one of said first and second separator tanks and said plurality of settling tanks;
a fluid heater mounted to said transportable skid and fluidically connected to at least one of said first and second separator tanks and said plurality of settling tanks;
one or more agitators having an outlet into one or more of said first and second separator tanks;
a circulation pump connected to said suction line and to said one or more agitators such said circulation pump draws from one or more settling tanks and discharges to said one or more agitators; and
a vacuum surface skimmer mounted to said skid and operably connected to one or more of said plurality of settling tanks.

2. The drilling fluid processing system of claim 1, wherein each of said first and second separator tanks and each of said plurality of settling tanks have a hopper-shaped bottom wall having a fluid outlet to which said suction line is connected.

3. The drilling fluid processing system of claim 1, wherein one or more of said settling tanks include a baffle for preventing liquid hydrocarbons floating on a surface of fluid therewithin from passing through an outlet thereof

4. The drilling fluid processing system of claim 1, wherein said plurality of settling tanks includes four settling tanks, and wherein said first and second separator tanks and said four settling tanks are connected for a fluid flow in parallel paths, wherein in a first path fluid flows from said first separator tank to a first settling tank and then from the first settling tank to a second settling tank, and wherein in a second path fluid flows from said second separator tank to a third settling tank and then from the third settling tank to a fourth settling tank.

5. The drilling fluid processing system of claim 4, wherein the first pump is connected to the first separator tank, the first settling tank, and the second settling tank to draw from their bottoms and fed to the first centrifugal separator, and wherein the second pump is connected to the second separator tank, the third settling tank, and the fourth settling tank to draw from their bottoms and fed to the second centrifugal separator.

6. The drilling fluid processing system of claim 5, wherein a solids discharge of said first centrifugal separator is connected to fed to said second separator tank and a fluid discharge of said first centrifugal separator is connected to fed to said first separator tank, and wherein a solids discharge of said second centrifugal separator is connected to fed to a shale bin and a fluid discharge of said second centrifugal separator is connected to fed to said second separator tank.

7. The drilling fluid processing system of claim 1, wherein said plurality of settling tanks includes four settling tanks, and wherein said first and second separator tanks and said four settling tanks are connected for a serial flow starting with the first separator tank, to the second separator tank, to a first settling tank, to a second settling tank, to a third settling tank, and then to a fourth settling tank.

8. The drilling fluid processing system of claim 7, wherein said first pump and second pump are connected to the first and second separator tanks, the first, second, third, and fourth settling tanks to draw from their bottoms and fed to said first and second centrifugal separator.

9. The drilling fluid processing system of claim 7, wherein a solids discharge of said first and second centrifugal separators is connected a shale bin and a liquid discharge of said first and second centrifugal separators is connected to a drilling rig.

10. The drilling fluid processing system of claim 7, wherein a solids discharge of said first and second centrifugal separators is connected to a shale bin and a liquid discharge of said first and second centrifugal separators is connected to said first separator tank.
